(19) United States
(12) Patent Application Publication
(10) Pub. No.: US 2004/0098370 A1
(43) Pub. Date: May 20, 2004

(54) Systems and methods to monitor file storage and transfer on a peer-to-peer network

(75) Inventors: Eric Garland, Pasadena, CA (US); Adam D. Toll, Atlanta, GA (US); Zack Allison, Atlanta, GA (US); Adam Allison, Atlanta, GA (US); J. Thomas Allison, Atlanta, GA (US)

Correspondence Address: HAYNES AND BOONE, LLP, 901 MAIN STREET, SUITE 3100, DALLAS, TX, 75202, US

(73) Assignee: BigChampagne, LLC, Atlanta, GA (US)

(21) Appl. No.: 10/714,283

(22) Filed: Nov. 14, 2003

Related U.S. Application Data
(60) Provisional application No. 60/426,904, filed on Nov. 15, 2002.

(51) Int. Cl. G06F 7/00

(52) U.S. Cl. 707/1

(57) ABSTRACT

A system that includes a computer coupled to a database and a network; the computer including an interception device adapted to make a copy of a plurality of search requests from the network; and a transfer device adapted to transfer the plurality of search requests from the computer to the database.

### RELATED APPLICATIONS

This application claims priority to U.S. Provisional Patent Application No. 60/426,904, filed on Nov. 15, 2002. U.S. Provisional Patent Application No. 60/426,904, filed on Nov. 15, 2002, and its associated appendices, are herein incorporated by reference in their entirety.

### FIELD

The present disclosure is related to monitoring queries, requests, file transfers and storage on peer-to-peer networks.

### RELATED ART

U.S. patent application Publication Ser. No. US 2002/0,087,885 A1, published on Jul. 4, 2002, the abstract of which states: “A system for external monitoring of networked digital file sharing to track predetermined data content, the system comprising: at least one surveillance element for deployment over said network, said surveillance elements comprising: surveillance functionality for searching said digital file sharing and identification functionality associated with said search functionality for identification of said predetermined data content, therewith to determine whether a given file sharing system is distributing said predetermined data content.” Publication Ser. No. US 2002/0,087,885 A1 is herein incorporated by reference in its entirety.

U.S. patent application Publication Ser. No. US 2002/0,069,098 A1, published on Jun. 6, 2002, the abstract of which states: “A method of controlling transfer of proprietary content on a computer network including the steps of identifying computers offering proprietary content on the computer network, identifying network addresses corresponding to the computers, identifying physical addresses corresponding to the network addresses and communicating a warning notice to at least one physical address.” Publication Ser. No. US 2002/0,069,098 A1 is herein incorporated by reference in its entirety.

U.S. patent application Publication Ser. No. US 2002/0,082,999 A1, published on Jun. 27, 2002, the abstract of which states: “A method of preventing reduction of sales amount of records due to a digital music file illegally distributed through a communication network is disclosed. The method comprises the steps of a)producing an advertising digital music file by deteriorating or damaging a sound quality of an original music file of a record of a cooperating record corporation; and b)distributing the advertising digital music file through the communication network. The present invention provides a method of producing a digital music file with lower sound quality for publicity, and distributing it over the network before a formal record is sold, thus minimizing a distribution of the illegal digital music file with the same quality as the original music file on the network.” Publication Ser. No. US 2002/0,082,999 A1 is herein incorporated by reference in its entirety.

U.S. patent application Publication Ser. No. US 2001/0,051,996 A1, published on Dec. 13, 2001, the abstract of which states: “A method and system for transferring electronic media information over a public network in such a way as to provide safeguards for inappropriate distribution of copyright or otherwise protected materials are described. The media information is transparently watermarked with a unique ID, such as one generated from X.509 Digital Certificate and public-key cryptography public/private key pairs, such that the information can be identified as belonging to a particular individual. A system and method for monitoring the movement of such watermarked files, positively identifying people who have inappropriately distributed copyright materials over a public network without permission, and taking appropriate enforcement action against such people.” Publication Ser. No. US 2001/0,051,996 A1 is herein incorporated by reference in its entirety.

U.S. patent application Publication Ser. No. US 2002/0,052,885 A1, published on May 2, 2002, the abstract of which states: “Peer-to-peer file sharing is increasing in popularity on the Internet, faster than any product known in history. Although file-sharing can enable massive piracy, it has many advantages for distribution of information including scalability. Alternatively, file-sharing can be sabotaged with falsified files and used to distribute viruses. To this end, a solution that maintains the scalability of file-sharing and promotes reliability is proposed. The solution involves embedding data within the file or content and using the data to identify the content, demonstrate its completeness and lack of viruses, and verify the file can be shared. The embedded data can be checked when the file is registered with the database for sharing, and before or while the file is being uploaded and/or downloaded. Ideally, the embedded data is added at the time of creation for the file. The embedded data may include a watermark and be linked to other copy management systems, such as those proposed in DVD and SDMI. Finally, the embedded data can be used to enable purchases of files that owners do not have rights to share.” Publication Ser. No. US 2002/0,052,885 A1 is herein incorporated by reference in its entirety.

U.S. patent application Publication Ser. No. US 2002/0,033,844 A1, published on Mar. 21, 2002, the abstract of which states: “The disclosure describes a method of connecting multimedia content to a network resource. This method operates in a computer network environment. Operating in a network connected device, the method extracts an identifier from a media signal, such as from a digital watermark, perceptual hash, or other machine extracted signal identifier. It then sends the identifier to a network along with context information indicating device type information. From the network, the method receives related data associated with the media signal via the identifier. The related data is adapted to the network connected device based on the device type information. This device type information may include a display type, so that the related date may be formatted for rendering on the display type of the device. This device type information may also include a connection speed so that the related data may be optimized for the connection speed of the device.” Publication Ser. No. US 2002/0,033,844 A1 is herein incorporated by reference in its entirety.

U.S. patent application Publication Ser. No. US 2002/0,007,350 A1, published Jan. 17, 2002, the abstract of which states: “A system for on demand data distribution includes a distribution engine and an index of distributable data files stored in peers. The distribution engine sends to a requesting peer an address of a peer having a requested data file and an encryption dataset to decrypt the data file. The distribution engine also charges a registered owner of the peer for purchase of the data file and updates the index to indicate that the requesting peer now stores the data file.” Publication Ser. No. US 2002/0,007,350 A1 is herein incorporated by reference in its entirety.

### SUMMARY

A system that includes a computer coupled to a database and a network; the computer including an interception device adapted to make a copy of a plurality of search requests from the network; and a transfer device adapted to transfer the plurality of search requests from the computer to the database.

### BRIEF DESCRIPTION OF THE DRAWINGS

FIG. 1 illustrates a peer-to-peer network;

FIG. 2 illustrates a system for processing and reporting search query information on a peer-to-peer network;

FIG. 3 illustrates a method for processing and reporting search query information on a peer-to-peer network;

FIG. 4 illustrates a system for collecting search query information on a peer-to-peer network;

FIG. 5 illustrates a table of query data;

FIG. 6 illustrates a table of query data;

FIG. 7 illustrates a table of query data;

FIG. 8 illustrates a report of query data;

FIG. 9 illustrates a peer-to-peer network;

FIG. 10 illustrates a system for processing and reporting inventory information on a peer-to-peer network;

FIG. 11 illustrates a method for processing and reporting inventory information on a peer-to-peer network;

FIG. 12 illustrates a system for collecting inventory information on a peer-to-peer network;

FIG. 13 illustrates a system for collecting inventory information on a peer-to-peer network;

FIG. 14 illustrates a table of file sharing data;

FIG. 15 illustrates a table of file sharing data;

FIG. 16 illustrates a table of file sharing data;

FIG. 17 illustrates a report of file sharing data;

FIG. 18 illustrates a system for processing file sharing and query data;

FIG. 19 illustrates a report of artist correlation data;

FIG. 20 illustrates a report of market data; and

FIG. 21 illustrates a report of artist data.

### DETAILED DESCRIPTION

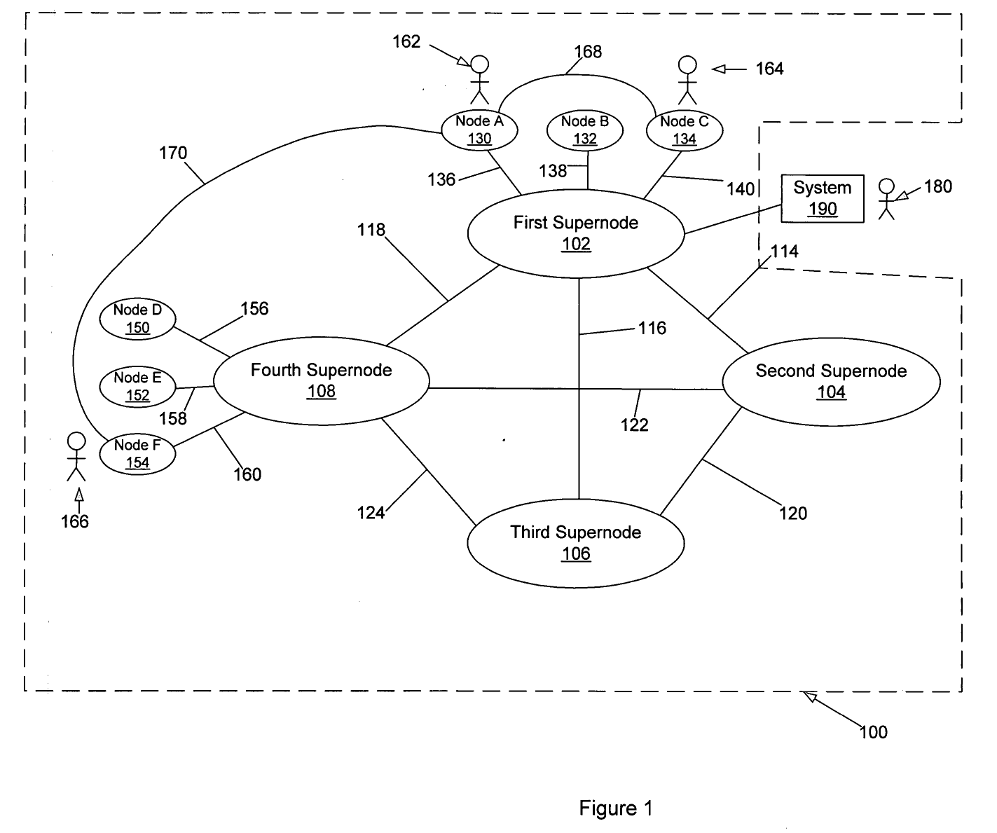

Referring to FIGS. 1-8, in one embodiment, a system and method of reporting query activity on peer-to-peer networks are illustrated. FIG. 1 illustrates an exemplary embodiment of a conventional peer-to-peer network, network 100, connected to system 190. Network 100 includes first supernode 102, second supernode 104, third supernode 106, and fourth supernode 108. First supernode 102 is coupled to second supernode 104 by connection 114, to third supernode 106 by connection 116, and to fourth supernode 108 by connection 118. Second supernode 104 is coupled to first supernode 102 by connection 114, third supernode 106 by connection 120, and fourth supernode by connection 122. Third supernode 106 is coupled to first supernode 102 by connection 116, second supernode 104 by connection 120, and fourth supernode 108 by connection 124. Fourth supernode 108 is coupled to first supernode 102 by connection 118, second supernode 104 by connection 122, and third supernode 106 by connection 124. There are three other nodes shown attached to first supernode 102: node A 130, node B 132, and node C 134. Node A 130 is coupled to first supernode 102 by connection 136. Node B 132 is coupled to first supernode 102 by connection 138. Node C 134 is coupled to first supernode 102 by connection 140.

Fourth supernode 108 is shown attached to node D 150, node E 152, and node F 154. Node D 150 is coupled to fourth supernode 108 by connection 156. Node E 152 is coupled to fourth supernode 108 by connection 158. Node F 154 is coupled to fourth supernode 108 by connection 160. System 190 operated by user 180 is coupled to network 100 by connection 192.

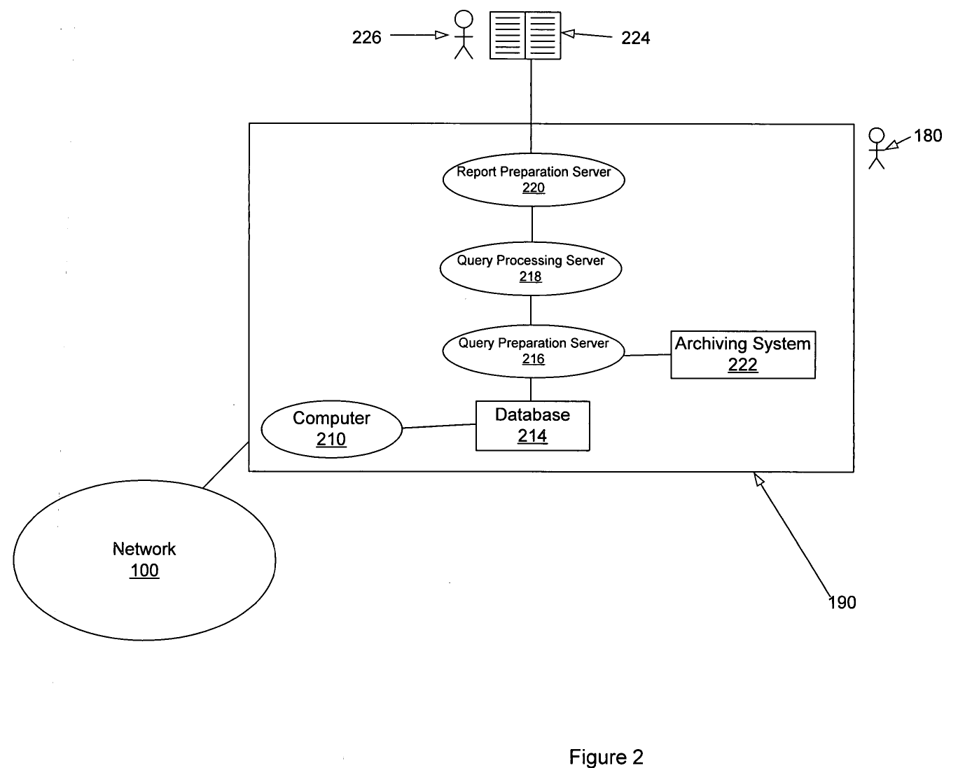

Referring to FIG. 2, system 190 is illustrated coupled to network 100. System 190 includes computer 210 coupled to database 214. Database 214 is coupled to query preparation server 216, which is coupled to query processing server 218, which is coupled to report preparation server 220. Archiving system 222 is coupled to query preparation server 216. User 180 operates system 190. Report preparation server 220 produces report 224 for customer 226.

Queries that system 190 intercepts are created by users on network 100. The operation of network 100 will be discussed to detail how queries are created, how system 190 is coupled to network 100, and how system 190 intercepts queries.

During operation of network 100, user 162 may be located at node A 130. If user 162 at node A 130 wants to find and/or download a file not stored on node A 130, user 162 can search/query other nodes and/or supernodes to find the file. User 162 can enter a search request/query into node A 130, which is carried to first supernode 102 by connection 136. If the file is located on first supernode 102, then the file can be sent from first supernode 102 to node A 130 by connection 136. If the file that user 162 wants is not located on first supernode 102, the search request/query may be sent to the other nodes, i.e., node B 132 and node C 134 coupled to first supernode 102. If the file that user 162 wants is located on node C 134, then connection 168 will be made between node A 130 and node C 134 to transfer the file from user 164 to user 162.

If the file that user 162 wants is not located on node B 132 or node C 134, then first supernode 102 will send the search request/query to second supernode 104, third supernode 106, and fourth supernode 108 to try and find the file that user 162 wants. Each supernode 104, 106, and 108 will then send the query to nodes and/or other supernodes coupled to that supernode. If user 166 has put the requested file on node F 154, then node F 154 will respond to fourth supernode 108 which will respond to first supernode 102, which will respond to node A 130. Then, connection 170 will be made between node F 154 and node A 130 to transfer the file that user 166 has loaded on node F 154 that user 162 requested.

Each time that user 162 sends a search query looking for a file, first supernode 102 sends those search queries to other nodes and/or supernodes, and in one embodiment, any user with a node and/or supernode could make a copy of and/or store every search query.

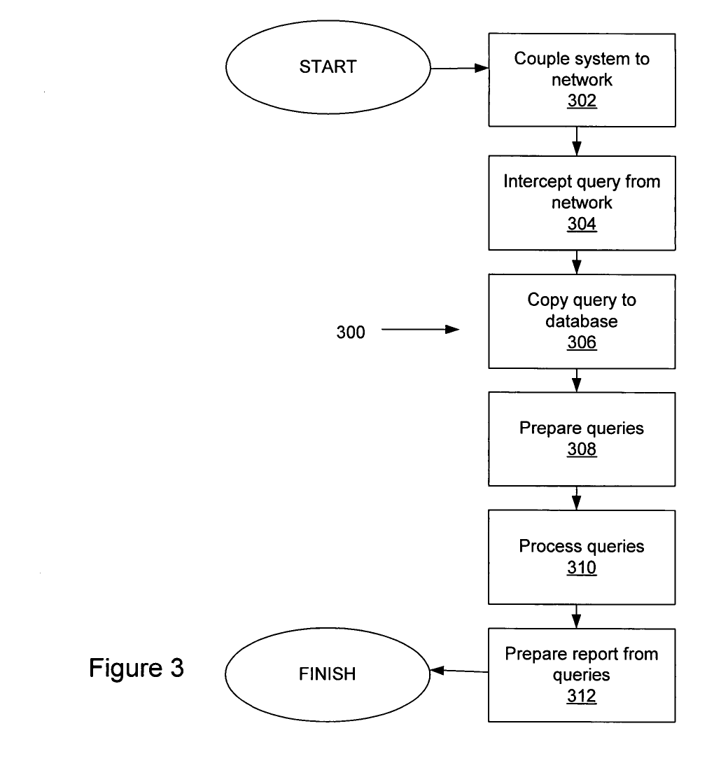

Referring to FIG. 3, method 300 of using system 190 is illustrated. System 190 is coupled to network 100 at step 302. System 190 intercepts queries from network 100 at step 304. Queries are copied to database 214 at step 306. Queries are prepared with query preparation server 216 at step 308. Queries are processed with query processing server 218 at step 310. Reports 224 are prepared with report preparation server 220 at step 312.

In the operation of system 190, computer 210 gathers query information from network 100 at step 304. Computer 210 passes the query information to database 214 at 306. Database 214 may include information such as IP address where the request/query came from, text of the requests, file format, for example, *.mp3, *.mpeg, etc., title of work included in file, artist(s) performing on file, date when file was requested, the system on which the file is stored, and/or when the record was created within database 214.

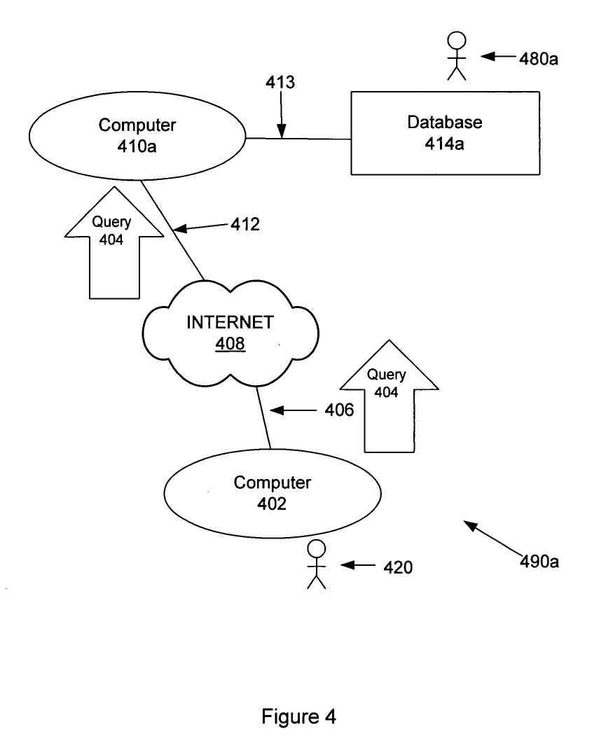

In an exemplary embodiment, as illustrated in FIG. 4, system 490a for performing steps 302-306 is illustrated. System 490a includes user 420 at computer 402 coupled to Internet 408 by connection 406. User 420 searches for files on network 100 by entering query 404 into computer 402. Query 404 is sent to Internet 408 by connection 406. System 490a also includes second computer 410a coupled to Internet 408 by connection 412. Second computer 410a is also coupled to database 414a by connection 413. Internet 408, which may include peer-to-peer network 100, functions by passing query 404 from computer 402 to other computers until a computer is found which has the file that user 420 is searching for. When query 404 is passed to second computer 410a, second computer 410a intercepts and/or copies the query and passes a copy of query 404 by connection 413 to database 414a where query 404 is stored.

Queries stored in database 414a allow user 480a to determine the most popular and/or least popular files and/or types of files based on the number of search queries per file.

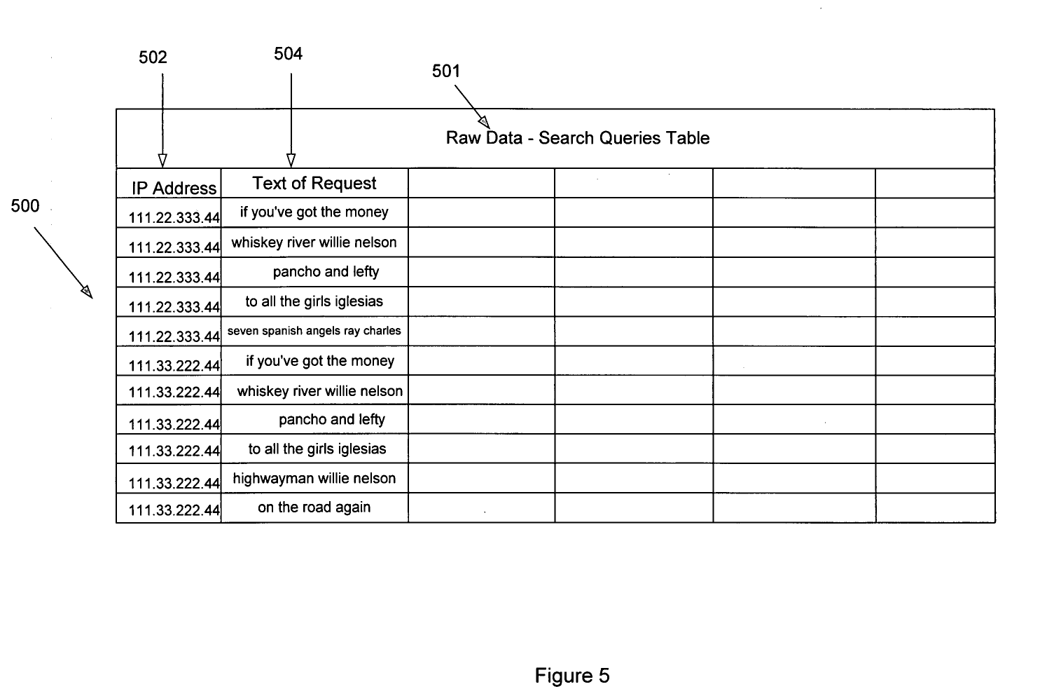

In an exemplary embodiment, at steps 304-306, a sample data table including a few records of queries intercepted from network 100 which may be included in database 214 or database 414a is illustrated in FIG. 5. Table 500 includes title 501, IP address 502 or other unique computer or user identifier where the request originated, and text of requests 504. Other information may also be included in table 500.

At step 308, query preparation server 216 combines the data from database 214 into a single source, and adds relevant information. The single source may be, for example, a flat file. The flat file can have source information detailing from which gathering system the information originated and at what time the query originated, for example to the second, or millisecond. The flat file can also have file information such as file name requested and/or text of the requests, file format requested, and when the file request was made. The flat file can also have user information such as the IP address where the file was requested from. The user information in the flat file may include the geographical location of the requesting user, if available.

In one embodiment, query preparation server 216 takes the raw data from databases 214 and/or 414a and combines them into a single source, then adds source information and user information including the geographical location of the requesting user at step 308. These processing steps by query preparation server 216 create the “Combined Prepared Set.”

Query preparation server 216 can process the raw data from database 214 to filter the data, for example to verify the integrity of the data, to produce the “Combined Prepared Set.”

After step 308, Query preparation server 216 passes a copy of Combined Prepared Set to query processing server 218. Query processing server 218 converts Combined Prepared Set to Final Query Set at step 310.

Query processing server 218 uses a variety of methodologies including one or more of the following: analysis of the text of the request, and a comparison of the exact string of text to a reference library of exact query strings previously identified. Query processing server 218 also adds key information about each file requested. This added information may include title being sought, for example, the title of a song, movie, software package, game, e-book, phone ringtone, etc., artist/author/performer being sought for example, the band name, singer's name, etc., publisher/label/studio of the property being sought for example, the game title publisher, record label, movie studio, etc., and other information such as album on which a given song being sought first appeared, year of publication of the requested song, and so forth.

Query processing server 218 adds information to the Combined Prepared Set to create the Final Query Set, from which reports will be generated. After step 310, query processing server 218 passes the Final Query Set to report preparation server 220.

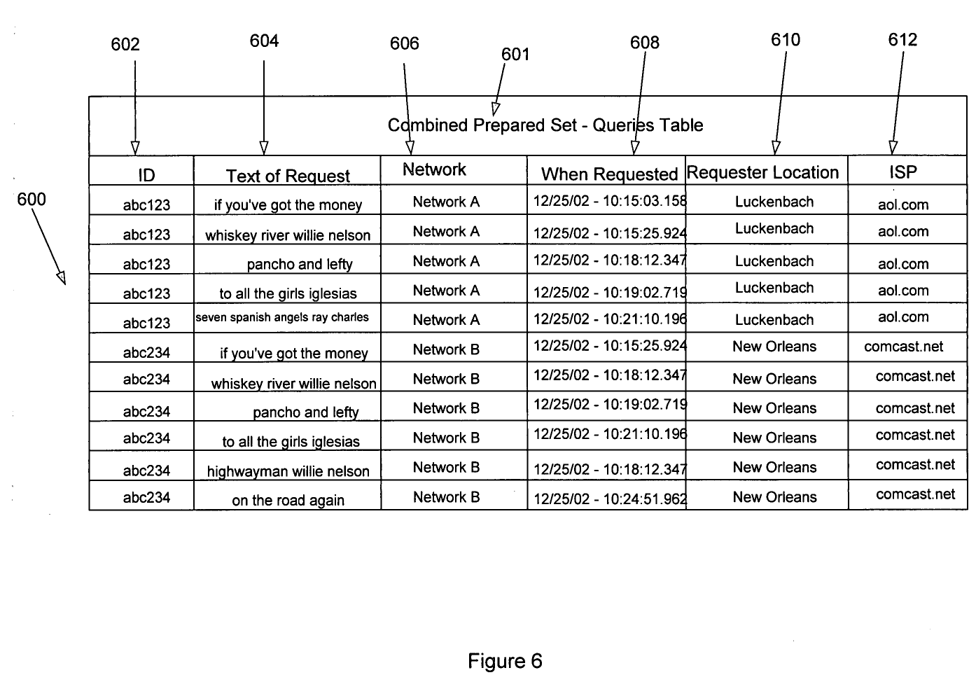

In an exemplary embodiment, at step 308, query preparation server 216 takes raw data table 500 (see FIG. 5), and converts it into combined prepared set table 600 (see FIG. 6).

Referring to FIG. 6, table 600 includes title 601, ID 602 of the requester which replaces IP address 502, text of the requests 604, network 606 from which the query was gathered, when the query was generated 608, location 610 of the requester, ISP 612 used by computer and/or user to access network 606. After the new data fields have been added and the integrity of the data has been verified, combined prepared set table 600 is complete.

In an exemplary embodiment, at step 308, in another embodiment, query preparation server 216 can process combined raw set table 500 to filter the data, for example to verify the integrity of the data, after which the combined prepared set table 600 is complete.

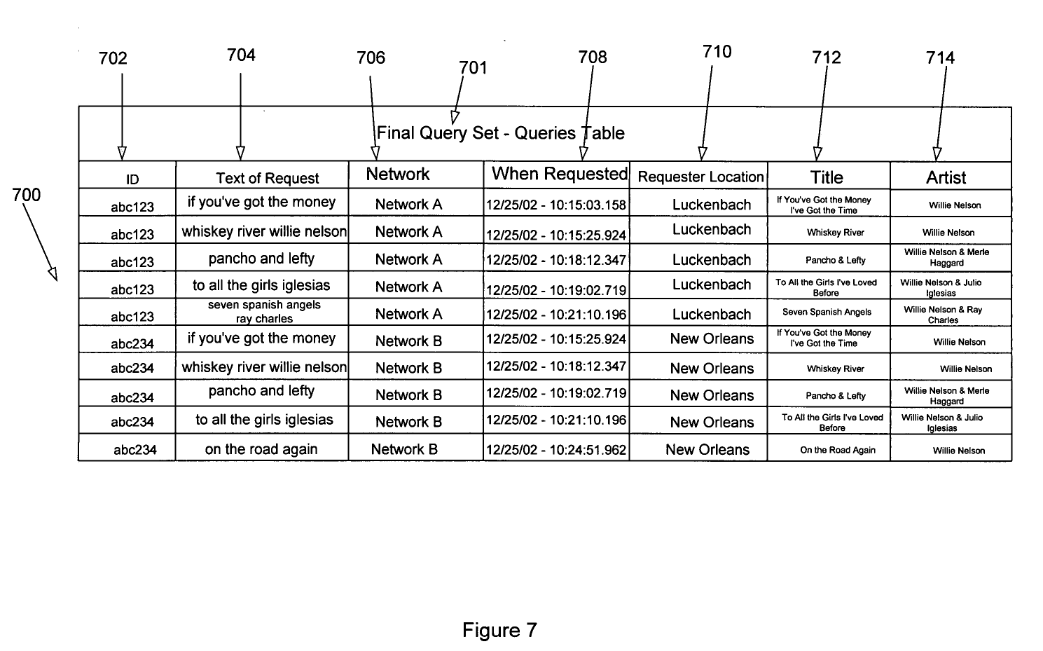

In an exemplary embodiment, at step 310, query processing server 218 takes combined prepared set table 600 (see FIG. 6), and creates final query set table 1300 (see FIG. 7).

Referring to FIG. 7, table 700 includes title 701, user ID 702 from which the request/query originated, text of the request 704, network 706 from which the query was gathered, when the query was generated 708, location 710 of the requester, title 712 of the requested work and/or file, and artist 714 or the person who performed the work included in the requested file. Other data fields may also be included in table 700, for example the ISP used to access network 706. Once all of the information is added to the data fields, Final Query Set table 700 is complete.

At step 312, report preparation server 220 uses Final Query Set to generate report 224 for customer 226. Report preparation server 220 refers to a Relevant Reports Table to identify which reports to generate for customer 226. The Relevant Reports Table is updated periodically, for example by automatic updates from partners and clients/customers as well as by manual updates to the table. Based on the contents of the Relevant Reports Table and using the Final Query Set, report preparation server 220 generates a variety of reports including, but not limited to, Artist reports and Album reports, showing trends in query and/or request activity by song, album and by artist overall, geographic location where this activity is originating, other artists that are also requested by users who request the subject artist, comparing one artist to others by these measures, charts plotting query and/or request activity along with Radio Airplay data by market, by radio format, for example “alternative rock”, by Radio Station, and other customized reports for customer 226.

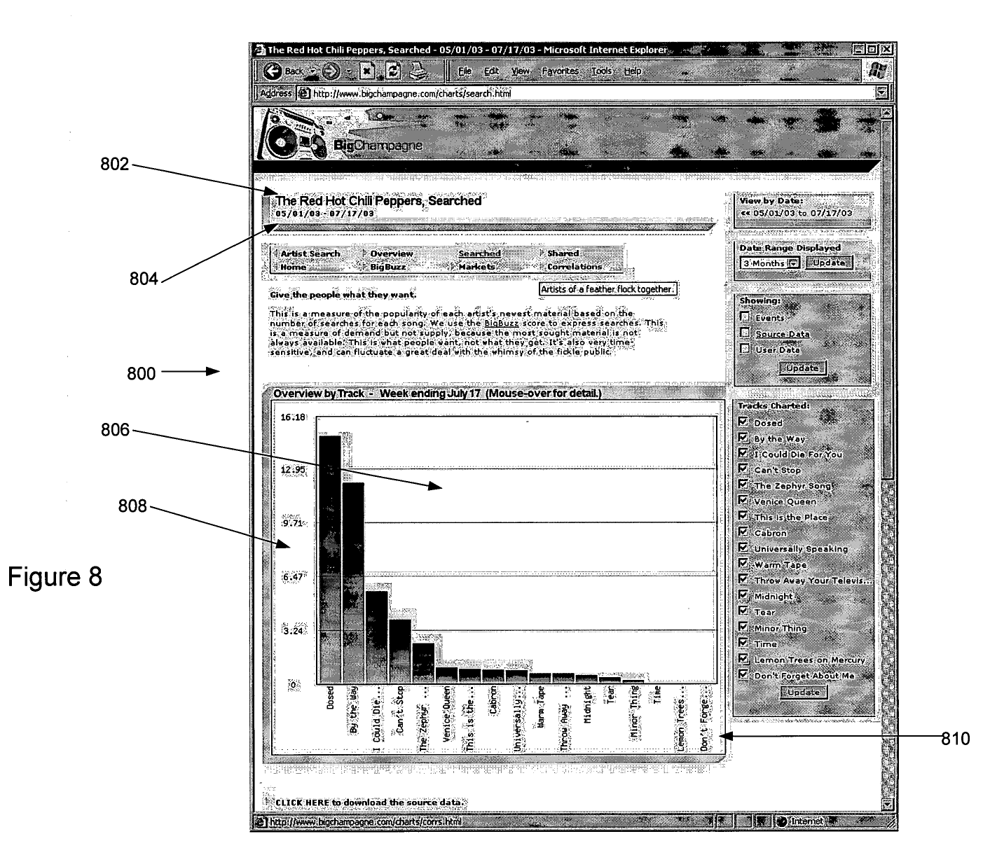

In an exemplary embodiment, at step 312, report preparation server 220 takes final query set table 700 (see FIG. 7), and creates search report 800 (see FIG. 8).

Referring to FIG. 8, search report 800 includes title 802, showing what artist or group was searched for, date range 804, of when the searches were conducted, and graph 806 showing popularity of songs by artist 802. Graph 806 includes popularity ranking 808 per song 810.

In another embodiment, user 180 at first supernode 102 could store a copy of every search request that crosses first supernode 102. In one embodiment, search requests are grouped into a “basket”, and passed around network 100 until they are filled. User 180 could store each search request or unique search request that passes through first supernode 102 on system 190. System 190 could then be used to determine the relative popularity based on the number of unique search requests of each type of file, particular files, authors, composers, producers, artists, and/or performers based on the universe of search requests across network 100 that flow through first supernode 102, and are stored on system 190.

In another embodiment, any user coupled to network 100 by a node and/or supernode could record and store a copy of every search request and/or query that crosses the user's node and/or supernode.

In another embodiment, there may be additional nodes and/or supernodes coupled to four supernodes 102,104, 106, and/or 108. However, only supernodes 1-4 102, 104,106, and 108; and nodes A-F 130,132,134,156,158, and 160 are illustrated, for simplicity.

In one embodiment, all connections are made over the Internet. In another embodiment, network 100 is a part of the Internet. In another embodiment, network 100 is part of a peer-to-peer network. In another embodiment, network 100 is a part of a commercially available peer-to-peer network. In another embodiment, network 100 is a part of a commercially available peer-to-peer network with users using a commercially available peer-to-peer network client.

In one embodiment, the connections between nodes and supernodes (topology) of network 100 changes over time. In one embodiment, a supernode may be a supernode based on the speed of its connection. In one embodiment, not all supernodes are coupled to each other. In one embodiment, a single node (child node) can be coupled to multiple supernodes. In another embodiment, network 100 may be an amorphous structure, with connections, nodes, and/or supernodes changing over time.

In another embodiment, a copy of Combined Prepared Set is stored on archiving system 122.

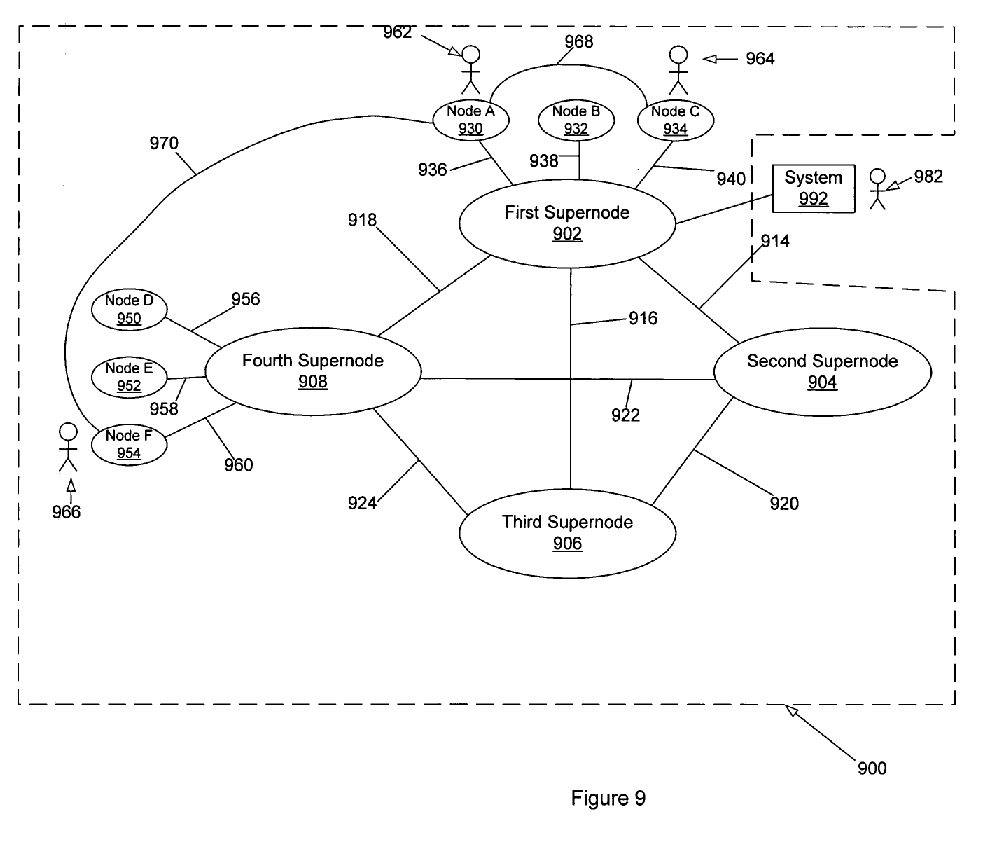

Referring to FIGS. 9-16, a system and method of reporting inventory on peer-to-peer networks are illustrated. FIG. 9 illustrates a conventional peer-to-peer network, network 900 coupled to system 992. Network 900 includes first supernode 902, second supernode 904, third supernode 906, and fourth supernode 908. First supernode 902 is coupled to second supernode 904 by connection 914, to third supernode 906 by connection 916, and to fourth supernode 908 by connection 918. Second supernode 904 is coupled to first supernode 902 by connection 914, third supernode 906 by connection 920, and fourth supernode by connection 922. Third supernode 906 is coupled to first supernode 902 by connection 916, second supernode 904 by connection 920, and fourth supernode 908 by connection 924. Fourth supernode 908 is coupled to first supernode 902 by connection 918, second supernode 904 by connection 922, and third supernode 906 by connection 924. There are three other nodes shown attached to first supernode 902: node A 930, node B 932, and node C 934. Node A 930 is coupled to first supernode 902 by connection 936. Node B 932 is coupled to first supernode 902 by connection 938. Node C 934 is coupled to first supernode 902 by connection 940.

Fourth supernode 908 is shown attached to node D 950, node E 952, and node F 954. Node D 950 is coupled to fourth supernode 908 by connection 956. Node E 952 is coupled to fourth supernode 908 by connection 958. Node F 954 is coupled to fourth supernode 908 by connection 960.

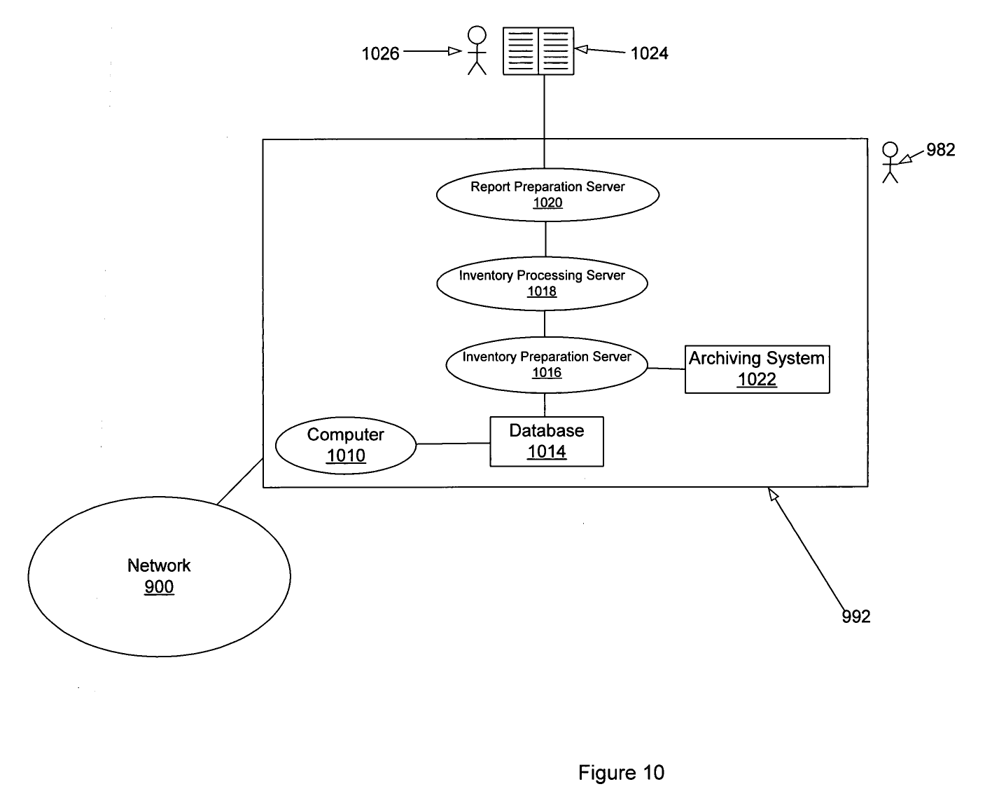

Referring to FIG. 10, system 992 is illustrated coupled to network 900. System 992 includes computer 1010 coupled to database 1014. Database 1014 is coupled to inventory preparation server 1016, which is coupled to inventory processing server 1018, which is coupled to report preparation server 1020. Archiving system 1022 is coupled to inventory preparation server 1016. User 982 operates system 992. Report preparation server 1020 produces report 1024 for customer 1026.

During operation of network 900, user 962 may be located at node A 930. If user 962 at node A 930 wants to find and/or download a file not stored on node A 930, user 962 can search other nodes and/or supernodes to find the file. User 962 can enter a search request/query into node A 930, which is carried to first supernode 902 by connection 936. If the file is located on first supernode 902, then the file can be sent from first supernode 902 to node A 930 by connection 936. If the file that user 962 wants is not located on first supernode 902, the search request/query may be sent to the other nodes, i.e., node B 932 and node C 934 coupled to first supernode 902. If the file that user 962 wants is located on node C 934, then connection 968 will be made between node A 930 and node C 934 to transfer the file from user 964 to user 962.

If the file that user 962 wants is not located on node B 932 or node C 934, then first supernode 902 will send the search request/query to second supernode 904, third supernode 906, and fourth supernode 908 to try and find the file that user 962 wants. Each supernode 904, 906, and 908 will then send the query to nodes and/or other supernodes coupled to that supernode. If user 966 has put the requested file on node F 954, then node F 954 will respond to fourth supernode 908 which will respond to first supernode 902, which will respond to node A 930. Then, connection 970 will be made between node F 954 and node A 930 to transfer the file that user 966 has loaded on node F 954 that user 962 requested.

Each time that user 962 sends a search query looking for a file, first supernode 902 sends those search queries to other nodes and/or supernodes, and in one embodiment, any user with a node and/or supernode could make a copy of and/or store every search query.

After user 962 receives the file on node A 930 from node F 954 by connection 970, user 962 could query node F 954 to determine every other file that user 966 has placed on node F 954. This would allow user 962 to determine the entire library of user 966 stored on node F 954. Similarly, any user coupled to network 900 by a node or a supernode, could determine the library of every other node and/or supernode by querying all of the other nodes/supernodes.

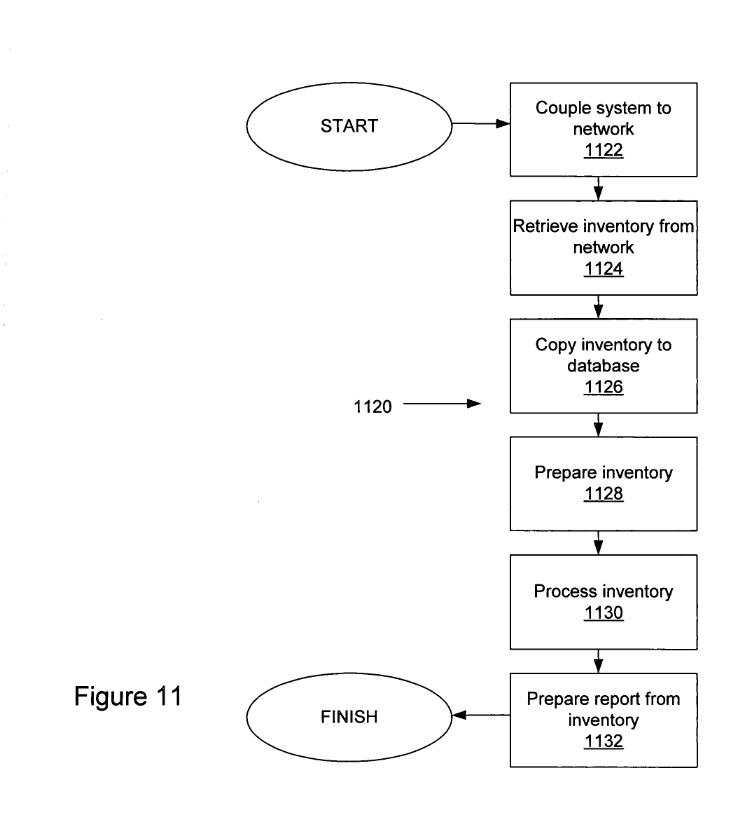

Referring to FIG. 11, method 1120 of using system 992 is illustrated. System 992 is coupled to network 900 at step 1122. System 992 intercepts inventory from network 900 at step 1124. Inventory is copied to database 1014 at step 1126. Inventory is prepared with inventory preparation server 1016 at step 1128. Inventory is processed with inventory processing server 1018 at step 1130. Reports 1024 are prepared with report preparation server 1020 at step 1132.

In the operation of system 992 at step 1124, computer 1010 gathers inventory information from network 900.

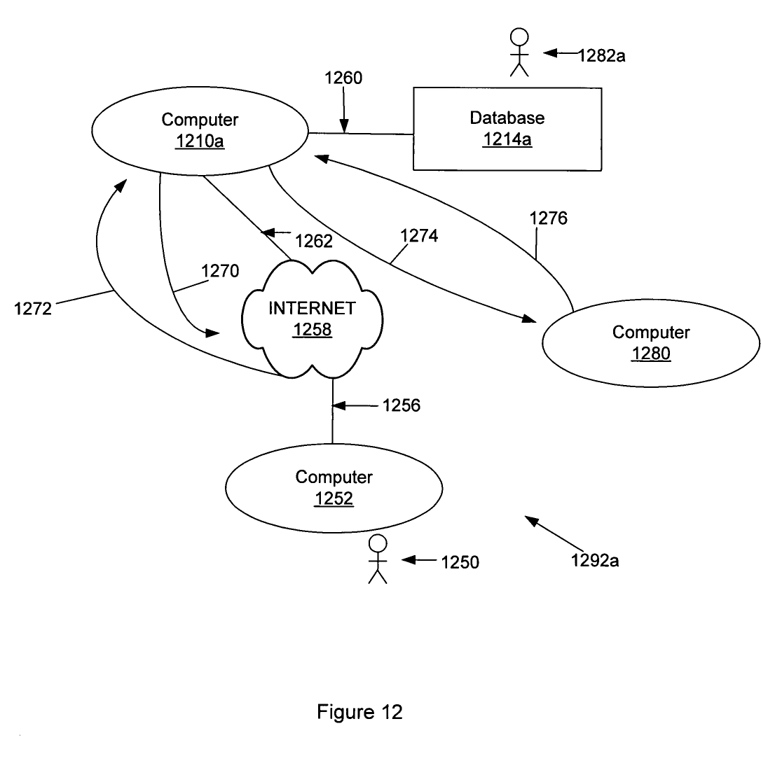

In an exemplary embodiment, as illustrated in FIG. 12, system 1292a for performing steps 1122-1126 is illustrated. System 1292a includes user 1250 at computer 1252 coupled to Internet 1258 by connection 1256. System 1292a also includes second computer 1210a coupled to database 1214a by connection 1260. Second computer 1210a is coupled to Internet 1258 by connection 1262. User 1282a may input generic search request/query 1270 into second computer 1210a which passes search request/query 1270 to Internet 1258. In one embodiment, generic search request/query is “*.MP3” In another embodiment, generic search request/query 1270 is “*.*” In another embodiment, generic search request/query is “*.MPEG” Other generic search requests are contemplated for use with this disclosure.

In response to generic search request/query 1270, user 1282a receives query reply 1272 via second computer 1210a, which includes a list of IP's, and/or computers that have one or more files that meet the requirements of the generic search request/query 1270.

User 1282a can then either manually and/or automatically enter a sampling of or every IP on list of IP's 1272 to determine list of files for each IP on list of IP's 1272. For a particular IP on query reply 1272, user 1282a may enter that particular IP and send request 1274 to computer 1280 associated with that particular IP to list all files in library of computer 1280. Computer 1280 responds to request 1274 with list of files 1276. Requests can also be made to other computers coupled to internet 1258 and/or on list of IP's to list all files shared. In another embodiment, a remote browse function to provide a list of all files associated with a particular IP, may include a search for “*.*”

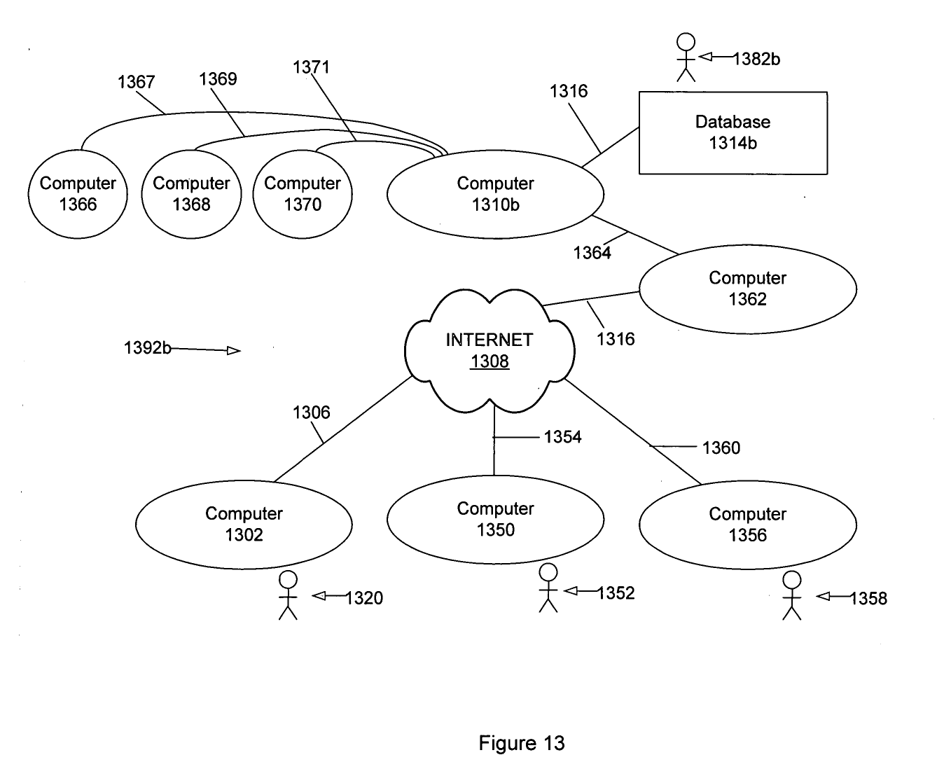

In an exemplary embodiment, as illustrated in FIG. 13, system 1392b for performing steps 1122-1126 is illustrated. System 1392b includes user 1320 at computer 1302 coupled to Internet 1308 by connection 1306; user 1352 at computer 1350 coupled to Internet 1308 by connection 1354; and user 1358 at computer 1356 coupled to Internet 1308 by connection 1360. System 1392b also includes computer 1310b coupled to database 1314b by connection 1316, and computer 1310b is also coupled to computer 1362 by connection 1364. Computer 1362 is coupled to Internet 1308 by connection 1316. Computer 1366 is coupled to computer 1310b by connection 1367; computer 1368 is coupled to computer 1310b by connection 1369; and computer 1370 is coupled to computer 1310b by connection 1371.

User 1382b may input search request/query (either manually and/or automatically) into one or more of computers 1366,1368, and/or 1370 which passes search request/query to computer 1310b by connection 1367, 1369, and/or 1371, to computer 1362 by connection 1364, which passes search request/query to Internet 1308 by connection 1316. In one embodiment, generic search request/query is “*.MP3” In another embodiment, generic search request/query is “*.*” In another embodiment, search request/query is “*.MPEG”

In response to search request/query, user 1382b receives query reply at computer 1362 which passes query reply to computer 1310b by connection 1364. Computer 1310b may pass parts of query reply to computer 1366 by connection 1367, computer 1368 by connection 1369, and/or computer 1370 by connection 1371, for example, to return the query reply to the computer that generated the search request. Query reply may include a list of IP's and/or computers, for example, computer 1302, 1350, and/or 1356 that have one or more files that meet the requirements of search request/query. For any of the IP's on query reply, computer 1366, computer 1368, and/or computer 1370 may query the IP and the associated computer, for example, computer 1302, computer 1350, and/or computer 1356 to list all media shared by the computers associated with those IP's, for example, computer 1302, computer 1350, and/or computer 1356. In one embodiment, computer 1366, computer 1368, and/or computer 1370 attempts to download all of the files for each computer associated with an IP address from the query reply.

In response, computer 1310b or computer 1362 blocks each download request, and stores a copy of each download request and/or passes a copy of each download request to database 1314b by connection 1316. In one embodiment, each computer associated with an IP address, for example computer 1302, computer 1350, and/or computer 1356, never receive the request to send all shared files in their respective libraries through Internet 1308, since computer 1310b or computer 1362 blocks each download request.

Computer 1310b stores a list of all the files in the library of each computer associated with each IP address, for example, computer 1302, computer 1350, computer 1356, and/or other computers coupled to system 1392b, in database 1314b by IP address, file, and/or file type.

After the library for each computer is stored in database 1314b, computer 1310b and/or computer 1362 halts or breaks connection to each computer, for example computer 1302, that one or more of computer 1366, computer 1368, and/or computer 1370 are attempting to download a file from. In one embodiment, the connection is halted for about one hour, in another embodiment for about 12 hours, and in another embodiment for about 24 hours. In one embodiment, the connection is halted so that computer 1366, computer 1368, and/or computer 1370 will not attempt to download files from the same remote computers, for example, computer 1302, computer 1350, and/or computer 1356. In this embodiment, after the connection has been halted, computer 1366, computer 1368, and/or computer 1370 will then attempt to download files from new remote computers that have not been recently accessed, for example within the past about one hour, in another embodiment about 12 hours, and in another embodiment about 24 hours.

At step 1126, computer 1010 passes the inventory information to database 1014. Database 1014 may include information such as IP address where the files are stored, file name, file format (eg—*.mp3, *.mpeg, etc.), title of work included in file, artist(s) performing on file, date when file was created, date when underlying work in file was created, the system on which the file is stored, metadata like length, bit rate, user comments, etc., and/or when the record was created within database 1014.

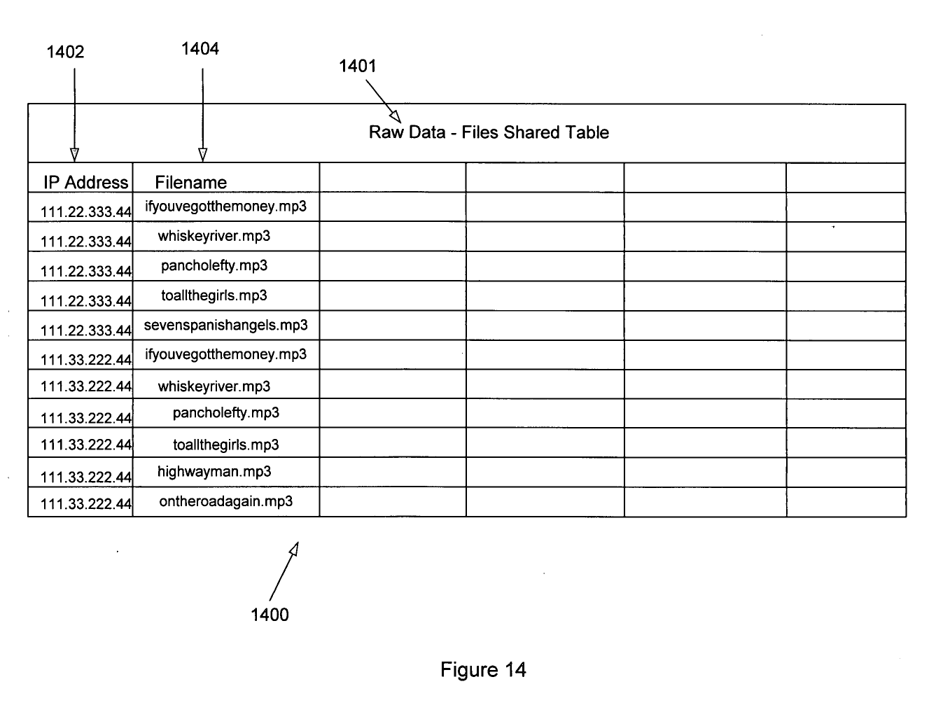

In an exemplary embodiment, as illustrated in FIG. 14, a sample data table including a few records which may be included in database 1014, database 1214a, and/or database 1314b at step 1126 is illustrated. Table 1400 includes title 1401, IP address 1402 or other unique computer or user identifier where the files are stored, and filenames 1404. Other information may also be included in table 1400.

At step 1128, inventory preparation server 1016 combines the data from database 1014 into a single source, and adds relevant information. The single source may be, for example, a flat file. The flat file can have source information detailing from which gathering system information originated and when the information was found. The flat file can also have file information such as file name, file format, and when the file was created. The flat file can also have user information such as an ID, indicating the user who had the computer where the file was stored. The user information in the flat file may include the geographical location of the user, if available, and/or the Internet Service Provider (ISP) that the user was using to access the network.

In one embodiment, inventory preparation server 1016 takes the raw data from database 1014 and combines them into a single source, then adds source information and user information including the geographical location of the user. These processing steps by inventory preparation server 1016 create the “Combined Raw Set.”

Inventory preparation server 1016 can process the Combined Raw Set, for example to verify the integrity of the data, to produce the “Combined Prepared Set.”

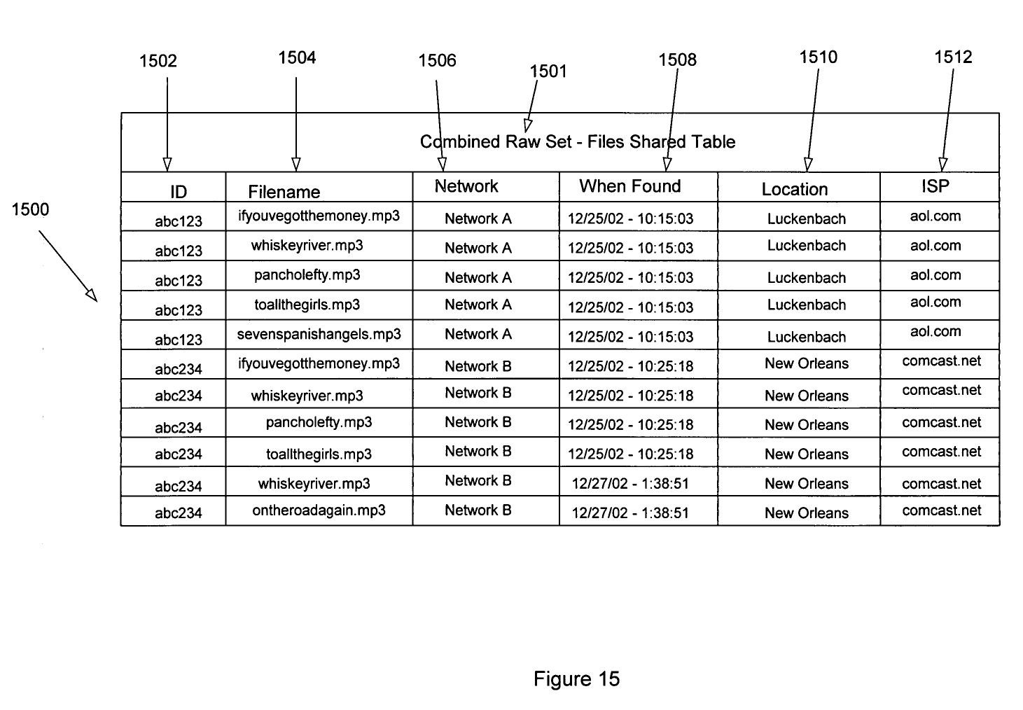

In an exemplary embodiment, as illustrated in FIG. 15, a sample data table which has been prepared by inventory preparation server 1016 at step 1128 is illustrated. In one embodiment, inventory preparation server 1016 takes raw data table 1400 (see FIG. 14), and converts it into combined raw set table 1500 (see FIG. 15). Table 1500 includes title 1501, user ID 1502 of the user and/or computer storing the file which replaces IP address 1402, filename 1504, network 1506 from which the information was gathered, when the information was found 1508, location 1510 where the file was stored, and ISP 1512 the user and/or computer was coupled to.

After step 1128, inventory preparation server 1016 passes a copy of Combined Prepared Set to inventory processing server 1018.

At step 1130, inventory processing server 1018 converts Combined Prepared Set to Final Inventory Set.

In one embodiment, inventory processing server 1018 uses a variety of methodologies including one or more of the following: waveform analysis, file hash calculation, file name analysis, size analysis, bit rate analysis, analysis of any and all other metadata associated with each file, and/or human analysis, to add key information about each file to the Combined Prepared Set in order to create the Final Inventory Set. Information that may be added in order to create the Final Inventory Set includes title (for example, title of a song, movie, software package, game, e-book, phone ringtone, etc.), artist/author/performer (for example, band name, singer's name, etc.), publisher/label/studio (for example, game title publisher, record label, movie studio, etc.) and other information such as album on which a given song appears, year of publication.

Inventory processing server 1018 adds information to the Combined Prepared Set to create the Final Inventory Set, from which reports will be generated.

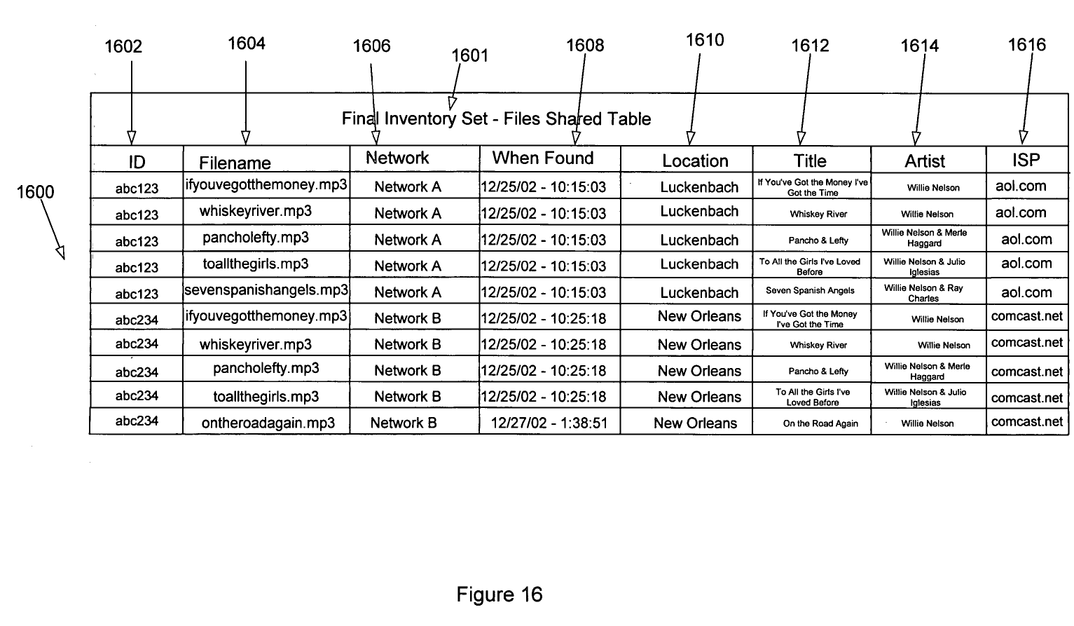

In an exemplary embodiment, as illustrated in FIG. 16, a sample data table which has been prepared by inventory processing server 1018 at step 1130 is illustrated. In one embodiment, inventory processing server 1018 takes combined set table 1500 (see FIG. 15), and adds information to create final inventory set table 1600 (see FIG. 16). Table 1600 includes user ID 1602, filename 1604, network 1606 from which the information was gathered, when the information was found 1608, location 1610 where the file is stored, title 1612 of the work included in the file, artist 1614 of the person who performed the work included in the file, and may also include ISP 1616 used by the computer and/or user to access the network. Other data fields may also be included in table 1600. Once all of the information is added to the data fields, Final Inventory Set Table 1600 is complete.

After step 1130, inventory processing server 1018 passes the Final Inventory Set to report preparation server 1020.

At step 1132, report preparation server 1020 uses Final Inventory Set to generate report 1024 for customer 1026. Report preparation server 1020 refers to a Relevant Reports Table to identify which reports to generate for customer 1026. The Relevant Reports Table is updated periodically, for example by automatic updates from partners and clients as well as manual updates to the table. Based on the contents of the Relevant Reports Table and using the Final Inventory Set, report preparation server 1020 generates a variety of reports including, but not limited to Artist reports and Album reports, showing trends in inventory (sharing) activity by song, album and by artist overall, geographic location of this activity, other artists that are also shared by users to share the subject artist, comparing one artist to others by these measures, charts plotting Inventory activity along with Radio Airplay data by market, by radio format (for example “alternative rock”), by Radio Station, and other customized reports for customer 1026.

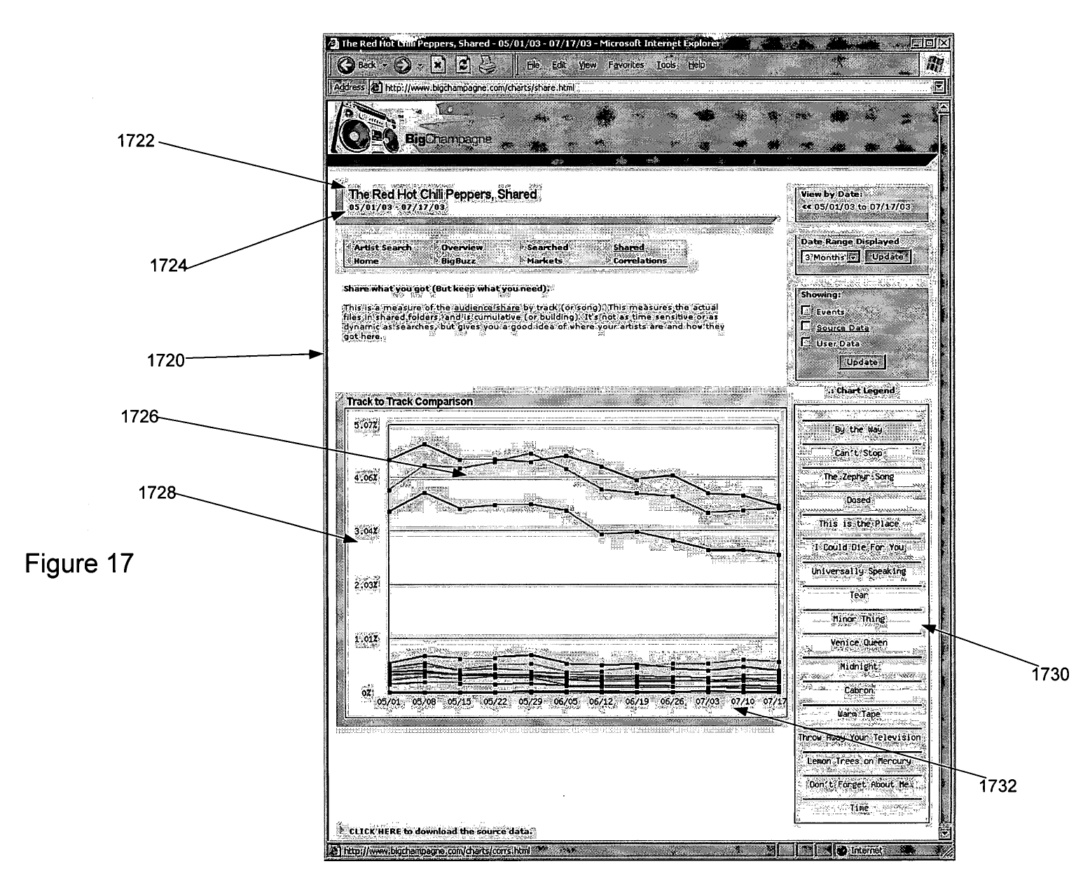

In an exemplary embodiment, as illustrated in FIG. 17, a sample report which has been prepared by report preparation server 1020 at step 1132 is illustrated. In one embodiment, report preparation server 1020 takes final inventory set table 1600 (see FIG. 16), and creates inventory report 1720 (see FIG. 17). Inventory report 1720 includes title 1722, showing what artist or group was included in the inventory, date range 1724, of when the inventory was surveyed, and graph 1726 showing popularity of songs by artist 1722. Graph 1726 includes popularity ranking 1728 per song 1730 by time 1732.

In another embodiment, there may be additional nodes and/or supernodes coupled to four supernodes 902, 904, 906, and/or 908. However, only supernodes 1-4 902, 904, 906, and 908; and nodes A-F 930, 932, 934, 956, 958, and 960 are illustrated, for simplicity.

In one embodiment, all connections are made over the Internet. In another embodiment, network 900 is a part of the Internet. In another embodiment, network 900 is part of a peer-to-peer network. In another embodiment, network 900 is a part of a commercially available peer-to-peer network. In another embodiment, network 900 is a part of a commercially available peer-to-peer network with users using a commercially available peer-to-peer network client.

In one embodiment, the connections between nodes and supernodes, the topology of network 900 changes over time. In one embodiment, a supernode may be a supernode based on the speed of its connection. In one embodiment, not all supernodes are coupled to each other. In one embodiment, a single node, a child node can be coupled to multiple supernodes. In another embodiment, network 900 may be an amorphous structure, with connections, nodes, and/or supernodes changing over time.

In another embodiment, a remote browse function to provide a list of all files associated with a particular IP, may include a search for “*.*”

In one embodiment, user 982 with supernode 902 and system 992 could determine the file inventory of all the other users and their respective nodes and/or supernodes. In one embodiment, user 982 sends a generic search request/query across network 900 to determine all the users with nodes and/or supernodes coupled to network 900. In one embodiment, generic search request/query could be all of the “MP3 files” stored on the nodes and/or supernodes. This could be accessed by a search request/query for “*.MP3” In another embodiment, generic search request/query could be all of the “MPEG files”, which could be accessed by a generic search request/query of “*.MPEG” Of course, other searches for other file types are possible and contemplated for use with this disclosure. The results of the generic search request/query by user 982 could be a list of all of the other users and/or the respective IP addresses of nodes/supernodes that have one or more files stored on the node or supernode that meet the requirements of the generic search request/query on their respective nodes and/or supernodes.

In another embodiment, user 982 requests a list of nodes from a supernode, to obtain a list of IP addresses associated with all nodes coupled to that supernode. For example, user 982 can request a list of nodes coupled to first supernode 902, and receive back a list including node a 930, node b 932, and node c 934, and their associated IP addresses.

Next, user 982 with supernode 902 could request a list of the entire library of every shared file stored on the respective nodes and/or supernodes associated with each unique IP address. A listing of the entire libraries of each node and/or supernode associated with each unique IP address could then be stored in system 992 to determine the collective library of network's 900 universe.

In another embodiment, system 992 coupled to first supernode 902 could be used to determine the relative popularity of each type of file and/or each particular file based on how many copies of the file are shared on nodes and supernodes. In another embodiment, system 992 could be used to determine the relative popularity of each file, type of file, author, composer, producer, artist, and/or performer of the listing of the files in the collective library for network 900.

In one embodiment, user 982 at supernode 902 and system 992 is coupled to network 990.

In another embodiment, a copy of Combined Raw Set and Combined Prepared Set are stored on archiving system 1022.

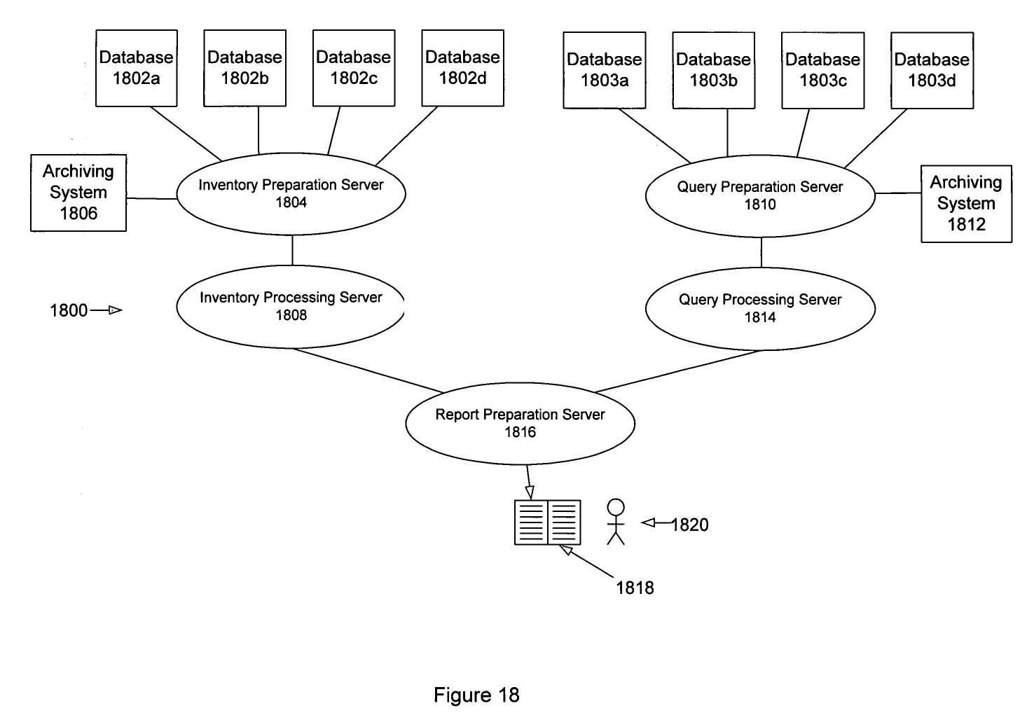

Referring now to FIG. 18, in another embodiment, there is illustrated system 1800 for processing information about files shared and requested on a peer-to-peer network, for example networks 100 and/or 900. In one embodiment, system 1800 may be used to process data and/or information from one or more of the networks and/or databases discussed above with reference to FIGS. 1-17.

System 1800 includes databases 1802a-1802d, which contain data regarding files shared on at least one peer-to-peer network. Data from databases 1802a-1802d is passed to inventory preparation server 1804, which combines the data from all the databases into a single database, and adds source information detailing which gathering system the information originated from, when the information was found, adds the geographic location of the filesharing computer on which the files are stored, to generate a Combined Raw Set. In another embodiment, other information may also be added to the Combined Raw Set.

Inventory preparation server 1804 also verifies the integrity the data, following which the Combined Prepared Set is complete.

Inventory preparation server 1804 sends a copy of both the Combined Raw Set and the Combined Prepared Set to data archiving system 1806. In one embodiment, archiving system 1806 includes a quadruple redundant archiving system, so that the two data sets are preserved with a lower risk of data loss.

Inventory preparation server 1804 sends a copy of the Combined Prepared Set to inventory processing server 1808.

Inventory processing server 1808 uses a variety of methodologies to add key information to the Combined Prepared Set to generate the Final Inventory Set. The key information includes such things as the title of the work included in the file, the artists and/or performers of the work included in the file, the publisher/label/studio of the work included in the file, and other key information. Once the key information has been added, the Final Inventory Set is complete.

Inventory processing server 1808 sends a copy of the Final Inventory Set to report preparation server 1816.

System 1800 also includes databases 1803a-1803d, which contain data regarding queries and/or files requested on a peer-to-peer network. Data from databases 1803a-1803d is passed to query preparation server 1810, which combines the data from all the databases into a single database, and adds source information detailing which gathering system the information originated from, when the query was generated, for example to the millisecond, adds the geographic location of the computer from which the query was generated, to generate a Combined Raw Set. In another embodiment, other information may also be added to the Combined Raw Set.

Inventory preparation server 1804 may also verify the integrity the data, following which the Combined Prepared Set is complete.

Query preparation server 1810 sends a copy of both the Combined Raw Set and the Combined Prepared Set to data archiving system 1812. In one embodiment, archiving system 1812 includes a quadruple redundant archiving system, so that the two data sets are preserved with a lower risk of data loss.

Query preparation server 1810 sends a copy of the Combined Prepared Set to query processing server 1814.

Query processing server 1814 uses a variety of methodologies to add key information to the Combined Prepared Set to generate the Final Query Set. The key information includes such things as the title of the work included in the requested file, the artists and/or performers of the work included in the requested file, the publisher/label/studio of the work included in the requested file, and other key information. Once the key information has been added, the Final Query Set is complete. In one embodiment, the methodologies include one or more of the methodologies detailed above with regards to query processing server 118 (see FIG. 6).

Query processing server 1814 sends a copy of the Final Query Set to report preparation server 1816.

Report preparation server 1816 receives the Final Inventory Set from inventory processing server 1808 and the Final Query Set from query processing server 1814. Report preparation server 1816 includes a Relevant Reports Table, where the table is used to identify which reports to generate. In one embodiment, the table is constantly updated through various means including automatic updates from partners and clients as well as manual updates to the table.

Based on the contents of the Relevant Reports Table, report preparation server 1816 uses the Final Inventory Set and the Final Query Set, to generate a variety of reports which may include one or more of the following: Artist Album reports, showing trends in query activity and inventory (sharing) activity by song, album and by artist overall; geographic location of this activity; other artists that are also shared and/or requested by users with the subject artist; comparing one artist to others by these measures; charts plotting query and inventory activity along with Radio Airplay data by market; by radio format (for example “alternative rock”); by Radio Station; and/or other custom reports.

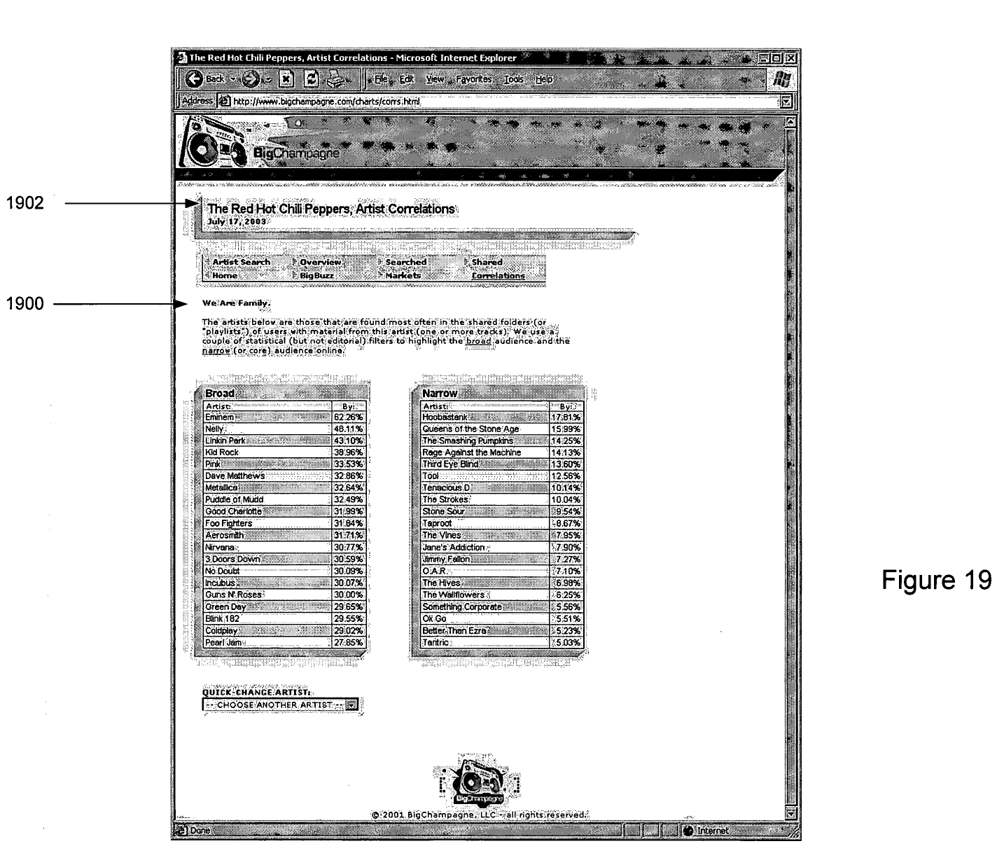

In an exemplary embodiment, as illustrated in FIG. 19, a sample report which has been prepared by report preparation server 1816 is illustrated. Report 1900 has title 1902 of Artist Correlation. This report is generated from inventory data of users who have a particular artist in their inventory, in this example the Red Hot Chili Peppers. This report provides a correlation between the particular artist and other artists that users have in their inventory.

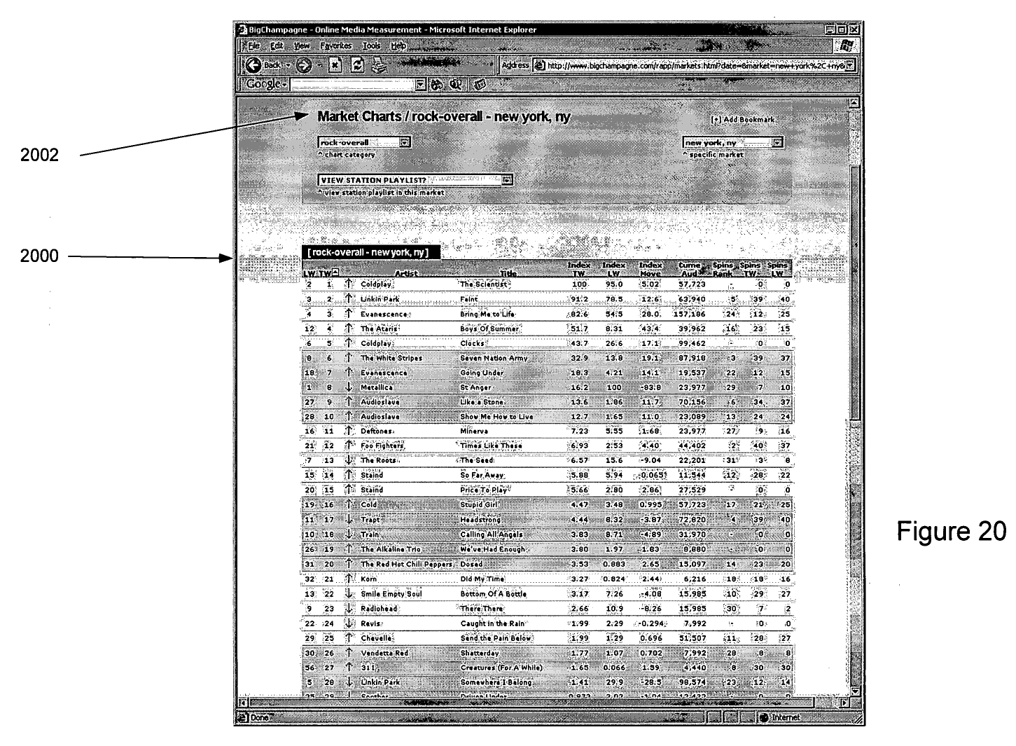

In an exemplary embodiment, as illustrated in FIG. 20, a sample report which has been prepared by report preparation server 1816 is illustrated. Report 2000 has title 2002 of Market Charts. This report is generated from inventory data and/or query data of users located in a particular geographic market that have requested a particular genre of music and/or share one or more files of that genre in their inventory. This report provides a ranking by geographic area and by genre of music of the most popular songs. The report also provides a correlation between popularity and radio airplay.

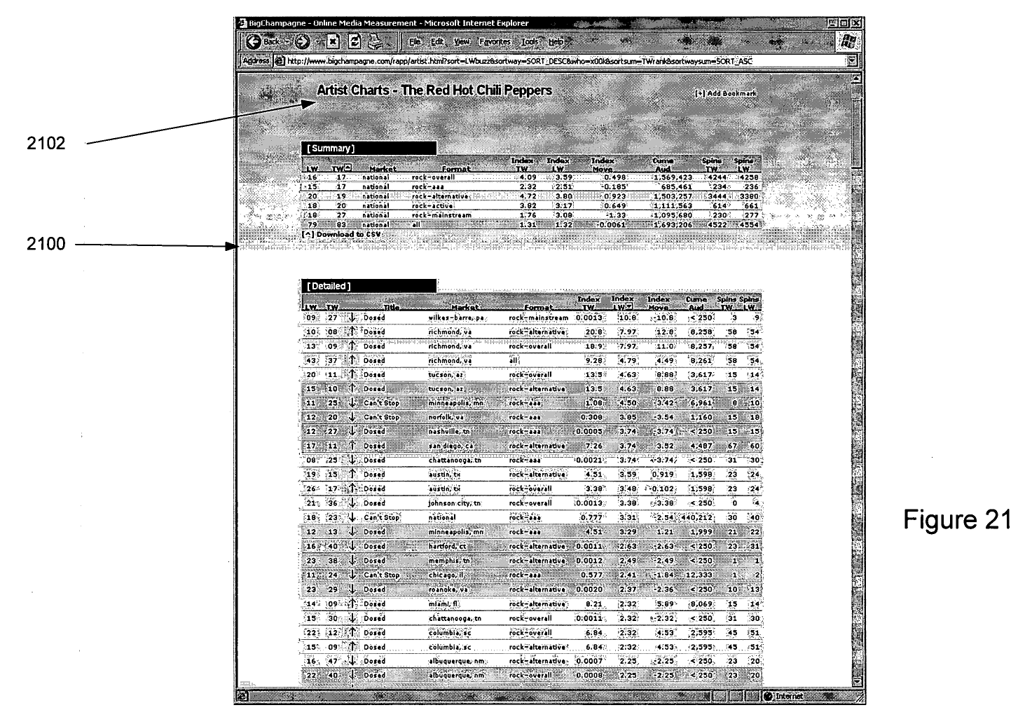

In an exemplary embodiment, as illustrated in FIG. 21, a sample report which has been prepared by report preparation server 1816 is illustrated. Report 2100 has title 2102 of Artist Summary. This report is generated from inventory data and/or query data of users who have requested a particular artist's music and/or share one or more files of that artist in their inventory. This report provides this artist's ranking by geographic area and by genre of music. The report also provides a correlation between artist popularity and radio airplay for some of the artist's songs.

In one embodiment, there is disclosed a system for tracking search requests on a file-sharing or peer-to-peer network including a computer coupled to the network; a database coupled to the computer; the computer including an interception device adapted to make a copy of a plurality of search requests on the network and a transfer device adapted to transfer the plurality of search requests from the computer to the database. In another embodiment, the system also includes a query preparation server. In another embodiment, the query preparation server is adapted to add source information to the plurality of search requests. In another embodiment, the source information includes the geographic location of at least one computer from which a search request was generated. In another embodiment, the query preparation server is adapted to add a time to each of the plurality of search requests, wherein the time is when each of the search requests was generated. In another embodiment, the system also includes an archiving system to store at least one copy of the plurality of search requests. In another embodiment, the system also includes a query processing server. In another embodiment, the system also includes a report preparation server. In another embodiment, the system also includes a query preparation server, a query processing server, and a report preparation server. In another embodiment, the system also includes a query device adapted to request a library of shared files from a plurality of computers coupled to the network. In another embodiment, the system also includes a second transfer device adapted to transfer the plurality of libraries of shared files from the computer to the database.

In one embodiment, there is disclosed a system for tracking file storage on a file-sharing or peer-to-peer network including a computer coupled to the network; a database coupled to the computer; the computer including a query device adapted to request a library of shared files from a plurality of computers coupled to the network and a transfer device adapted to transfer the plurality of libraries of shared files from the computer to the database. In another embodiment, the system also includes an inventory preparation server. In another embodiment, the inventory preparation server is adapted to add source information to the plurality of libraries. In another embodiment, the source information includes the geographic location of at least one computer on which a library was stored. In another embodiment, the query preparation server is adapted to add a time to each of the plurality of libraries, wherein the time is when each of the libraries was found. In another embodiment, the system also includes an archiving system to store at least one copy of the plurality of libraries. In another embodiment, the system also includes an inventory processing server. In another embodiment, the system also includes a report preparation server. In another embodiment, the system also includes an inventory preparation server, an inventory processing server, and a report preparation server. In another embodiment, the system also includes an interception device adapted to make a copy of a plurality of search requests on the network. In another embodiment, the system also includes a second transfer device adapted to transfer the plurality of search requests from the computer to the database.

In one embodiment, there is disclosed a method of tracking search requests on a file-sharing or peer-to-peer network including coupling a computer to a database; coupling the computer to the network; intercepting a plurality of search requests on the network, where said plurality of search requests come to said computer; copying said plurality of search requests; and transferring the plurality of search requests from the computer to the database. In another embodiment, the method also includes sending the plurality of search requests back to the network. In another embodiment, the method also includes adding source information to each of the plurality of search requests. In another embodiment, the source information comprises the geographic location of where the search request originated. In another embodiment, the method also includes adding a time at which each search request was generated. In another embodiment, the method also includes locating a plurality of computers coupled to the network by IP address; and requesting a listing of a library of shared files from each of said plurality of computers coupled to the network. In another embodiment, the method also includes generating at least one report including data from a plurality of search requests.

In one embodiment, there is disclosed a method of tracking file storage on a file-sharing or peer-to-peer network including coupling a computer to a database; coupling the computer to the network; locating a plurality of computers coupled to the network by IP address; requesting a listing of a library of shared files from each of said plurality of computers coupled to the network; and transferring the listing of the plurality of libraries of shared files from the computer to the database. In another embodiment, the method also includes adding source information to each of the listings. In another embodiment, the source information comprises the geographic location of a computer where the library is stored. In another embodiment, the method also includes intercepting a plurality of search requests on the network, where said plurality of search requests come to said computer; and copying said plurality of search requests. In another embodiment, the method also includes transferring the plurality of search requests from the computer to the database. In another embodiment, the method also includes generating at least one report including data from a plurality of listings. In another embodiment, the method also includes generating at least one report including data from a plurality of listings and a plurality of search requests.

In one embodiment, there is disclosed a system for tracking search requests on a file-sharing or peer-to-peer network including a means for intercepting a plurality of search requests on the network; a means for copying the plurality of search requests; a means for storing the plurality of search requests; and a means for processing the plurality of search requests. In another embodiment, the system also includes a means for generating a report based on the plurality of search requests. In another embodiment, the system also includes a means for locating a plurality of users on the network; and a means for obtaining a listing of shared files from each of the plurality of users. In another embodiment, the system also includes a means for generating a report based on the plurality of search requests and the listing of shared files.

The above-described embodiments of the present disclosure include a number of reference numerals provided to aid in the understanding of the disclosed devices and methods. Although the same or similar reference numerals have been used in multiple figures and for multiple embodiments for the sake of convenience, it should not be assumed that the same reference numeral refers to the same element or that similarly numbered elements are the same element in each of the figures and embodiments.

The above description of the embodiments according to the disclosure are merely examples, and, thus, variations that do not depart from the gist of the disclosure are intended to be within its scope. Such variations are not to be regarded as a departure from the spirit and scope of the invention. In addition, the various embodiments discussed above are used to illustrate the components and functioning of the systems and methods, and should not be used to interpret the scope of the claims set forth below.

1. A system for tracking search requests on a file-sharing or peer-to-peer network comprising:
a computer coupled to the network;
a database coupled to the computer;
the computer comprising:
an interception device adapted to make a copy of a plurality of search requests from the network; and
a transfer device adapted to transfer the plurality of search requests from the computer to the database.

2. The system of claim 1, further comprising a query preparation server coupled to the database.

3. The system of claim 1, further comprising an archiving system coupled to the database, the archiving system to store at least one copy of the plurality of search requests.

4. The system of claim 1, further comprising a query processing server coupled to the database.

5. The system of claim 1, further comprising a report preparation server coupled to the database.

6. The system of claim 1, further comprising a query preparation server coupled to the database, a query processing server coupled to the query preparation server, and a report preparation server coupled to the query processing server.

7. The system of claim 1, the computer further comprising a query device adapted to request a library of shared files from a plurality of computers connected to the network.

8. The system of claim 7, the computer further comprising a second transfer device adapted to transfer the plurality of libraries of shared files from the computer to the database.

9. A system for tracking file storage on a file-sharing or peer-to-peer network comprising:
a computer coupled to the network;
a database coupled to the computer;
the computer comprising:
a query device adapted to request a library of shared files from a plurality of computers connected to the network; and
a transfer device adapted to transfer the plurality of libraries of shared files from the computer to the database.

10. The system of claim 9, further comprising an inventory preparation server coupled to the database.

11. The system of claim 9, further comprising an archiving system coupled to the database, the archiving system to store at least one copy of the plurality of libraries.

12. The system of claim 9, further comprising an inventory processing server coupled to the database.

13. The system of claim 9, further comprising a report preparation server coupled to the database.

14. The system of claim 9, further comprising an inventory preparation server coupled to the database, an inventory processing server coupled to the inventory preparation server, and a report preparation server coupled to the inventory processing server.

15. The system of claim 9, the computer further comprising an interception device adapted to make a copy of a plurality of search requests from the network.

16. The system of claim 15, the computer further comprising a second transfer device adapted to transfer the plurality of search requests from the computer to the database.

17. A method of tracking search requests on a file-sharing or peer-to-peer network comprising:
coupling a computer to a database;
coupling the computer to the network;
intercepting a plurality of search requests on the network, where said plurality of search requests come to said computer;
copying said plurality of search requests; and
transferring the plurality of search requests from the computer to the database.

18. The method of claim 17, further comprising sending the plurality of search requests back to the network.

19. The method of claim 17, further comprising adding source information to each of the plurality of search requests.

20. The method of claim 19, wherein the source information comprises the geographic location and internet service provider of where the search request originated.

21. The method of claim 17, further comprising adding a time at which each search request was generated.

22. The method of claim 17, further comprising locating a plurality of computers connected to the network by IP address; and requesting a listing of a library of shared files from each of said plurality of computers connected to the network.

23. The method of claim 17, further comprising generating at least one report including data from a plurality of search requests.

24. A method of tracking file storage on a file-sharing or peer-to-peer network comprising:
coupling a computer to a database;
coupling the computer to the network;
locating a plurality of computers connected to the network by IP address;
requesting a listing of a library of shared files from each of said plurality of computers connected to the network; and
transferring the listing of the plurality of libraries of shared files from the computer to the database.

25. The method of claim 24, further comprising adding source information to each of the listings.

26. The method of claim 25, wherein the source information comprises the geographic location of a computer where the library is stored.

27. The method of claim 24, further comprising intercepting a plurality of search requests on the network, where said plurality of search requests come to said computer; and copying said plurality of search requests.

28. The method of claim 27, further comprising transferring the plurality of search requests from the computer to the database.

29. The method of claim 24, further comprising generating at least one report including data from a plurality of listings.

30. The method of claim 29, further comprising generating at least one report including data from a plurality of listings and a plurality of search requests.

31. A system for tracking search requests on a file-sharing or peer-to-peer network comprising:
a means for intercepting a plurality of search requests on the network;
a means for copying the plurality of search requests;
a means for storing the plurality of search requests; and
a means for processing the plurality of search requests.

32. The system of claim 31, further comprising:
a means for generating a report based on the plurality of search requests.

33. The system of claim 31, further comprising:
a means for locating a plurality of users on the network; and
a means for obtaining a listing of shared files from each of the plurality of users.

34. The system of claim 33, further comprising:
a means for generating a report based on the plurality of search requests and the listing of shared files.
